(19) United States
(12) Patent Application Publication
(10) Pub. No.: US 2007/0132534 A1
(43) Pub. Date: Jun. 14, 2007

(54) TRANSFORMER AND METHOD OF ASSEMBLY

(76) Inventor: Kevin P. Osbun, Fort Wayne, IN (US)

Correspondence Address: PATRICK W. RASCHE (12552), ARMSTRONG TEASDALE LLP, ONE METROPOLITAN SQUARE, SUITE 2600, ST. LOUIS, MO, 63102-2740, US

(21) Appl. No.: 11/613,510

(22) Filed: Dec. 20, 2006

Related U.S. Application Data
(63) Continuation-in-part of application No. 11/297,158, filed on Dec. 8, 2005.

(51) Int. Cl. H01F 21/12

(52) U.S. Cl. 336/150

(57) ABSTRACT

A transformer includes a frame and a coil comprising a conductor winding. The conductor winding includes an end having a first opening. The transformer also includes a terminal coupled to the frame. The terminal includes a second opening. A fastener is received within the first and second openings. The fastener fixedly secures said conductor winding end to said terminal to electrically couple said conductor winding to said terminal.

### CROSS-REFERENCE TO RELATED APPLICATIONS

This application claims the priority of and is a Continuation in Part of U.S. patent application Ser. No. 11/297,158 filed Dec. 8, 2005, which is hereby incorporated by reference in its entirety.

### BACKGROUND OF THE INVENTION

This invention relates generally to electrical transformers, and more specifically to methods for assembling electrical transformers.

At least some known electrical transformers include one or more coils mounted on a base, or frame. Each coil includes two or more conductor windings. Some known transformers include a plurality of terminals for circuit connections. The terminals are connected to the ends of the coil windings. More specifically, in at least some known transformers, for example medium power dry-type transformers, the coil windings ends are welded to the terminals. However, welding the coil winding ends to the terminals may require welding equipment, welding supplies, and/or operator training, which may increase a cost of assembling the transformer. Moreover, the welding process may increase at time of assembling the transformer.

In at least some known transformers, the terminals are mounted on a terminal board assembly that electrically insulates each of the terminals from each other and other components of the transformer. However, because transformers and their components may have a variety of sizes and shapes, at least some known transformers may require different sized and/or shaped terminal board assemblies, which may increase a cost of manufacturing transformers. Moreover, some known terminal board assemblies may be machined to fit the transformer, which may increase a cost and/or a time of manufacturing transformers.

### BRIEF DESCRIPTION OF THE INVENTION

In one aspect, a transformer includes a frame and a coil having a conductor winding. The conductor winding includes an end having a first opening. The transformer also includes a terminal coupled to the frame. The terminal includes a second opening. A fastener is received within the first and second openings. The fastener fixedly secures said conductor winding end to said terminal to electrically couple said conductor winding to said terminal.

In another aspect, a transformer includes a frame, a coil comprising a first conductor winding and a second conductor winding, a first insulator coupled to the frame, a first terminal extending from the first insulator to facilitate electrically isolating the first terminal from the frame. The first terminal is electrically coupled to the first conductor winding. The transformer also includes a second insulator independent from the first insulator and coupled to the frame, wherein the first and second insulators are independently coupled to the frame. A second terminal is electrically coupled to the second conductor winding. The second terminal extends from the second insulator to facilitate electrically isolating the second terminal from the frame and the first terminal.

In another aspect, a transformer includes a frame and a coil having a conductor winding. The conductor winding includes an end. A terminal is coupled to the frame, and a clamp fixedly secures the conductor winding end to the terminal to electrically couple the conductor winding to the terminal.

In another aspect, a method is provided for assembling a transformer including a terminal and a coil having a conductor winding. The method includes providing a first opening within an end of the conductor winding, providing a second opening within the terminal of the transformer, and fixedly securing the conductor winding end to the terminal by receiving a fastener within the first and second openings to facilitate electrically coupling the conductor winding to the terminal.

In another aspect, a method is provided for assembling a transformer including a terminal and a coil having a conductor winding. The method includes providing a clamp, and fixedly securing the conductor winding to the terminal using the clamp to facilitate electrically coupling the conductor winding to the terminal.

In another aspect, a method is provided for assembling a transformer including a frame and a plurality of terminals. The method includes providing a plurality of independent insulators, and independently coupling each of the plurality of terminals to the frame using the plurality of independent insulators.

### BRIEF DESCRIPTION OF THE DRAWINGS

FIG. 1 is a perspective view of an exemplary embodiment of a transformer.

FIG. 2 is a perspective view of a portion of the transformer shown in FIG. 1.

FIG. 3 is another perspective view of the transformer portion shown in FIG. 2.

FIG. 4 is an exploded perspective view of the transformer portion shown in FIGS. 2 and 3.

FIG. 5 is a perspective view of a portion of an alternative embodiment of the transformer shown in FIG. 1.

FIG. 6 is a perspective view of the transformer portion shown in FIG. 5.

### DETAILED DESCRIPTION OF THE INVENTION

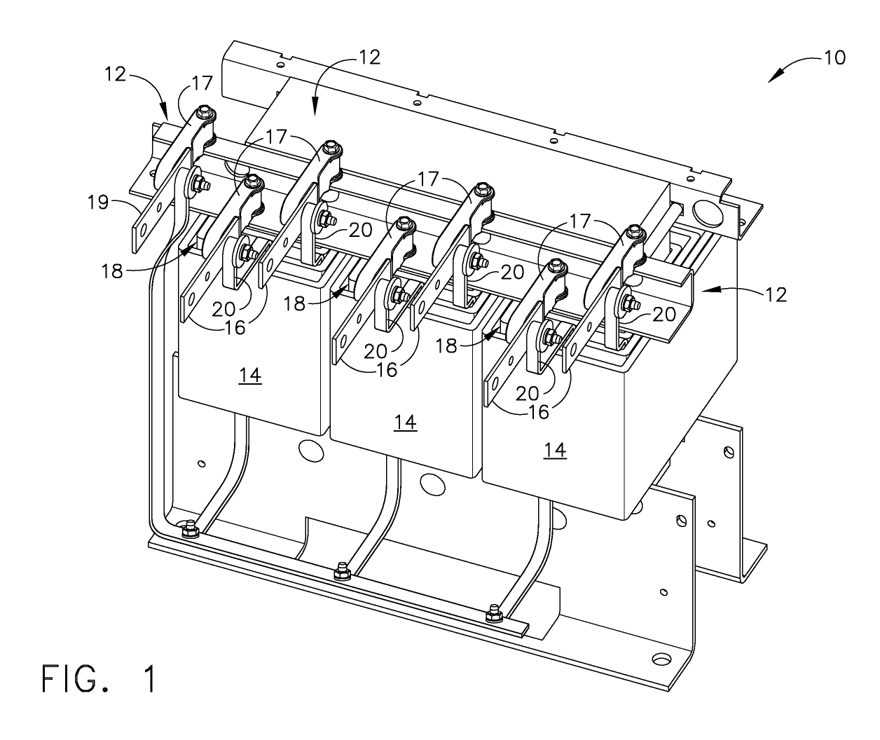

FIG. 1 is a perspective view of an exemplary embodiment of a transformer 10. Transformer 10 generally includes a frame 12, a plurality of coils 14 coupled to frame 12, and a plurality of terminals 16 coupled to frame 12 via a plurality of corresponding, and independent, insulators 17. Transformer 10 may be any type of transformer. For example, in the exemplary embodiment transformer 10 is a medium power dry-type transformer, however transformer 10 may be another type of transformer. Coils 14 each include two or more windings 18 of a conductor 20 that are each wound around a core (not shown) for transferring electrical energy therebetween. Although in the exemplary embodiment each winding 18 is formed from only one conductor, each winding may include any number of conductor(s). Each coil 14 may be any type of coil, for example including any number of conductor windings 18, any number of turns of each conductor winding 18, any size, shape, and/or material of each conductor 20 forming a winding 18, and/or any size, shape, and/or material of a core. Although three coils 14 are illustrated, transformer 10 may include any number of coils 14. Coils 14 may each be coupled to frame in any suitable fashion, manner, configuration, arrangement, location, orientation, method, process, and/or by any suitable structure and/or means.

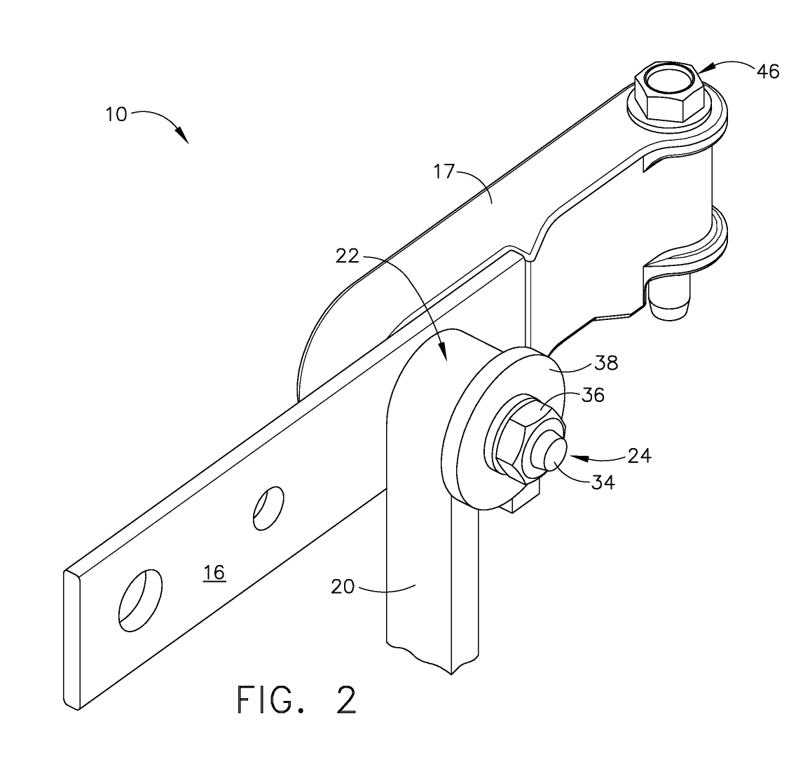

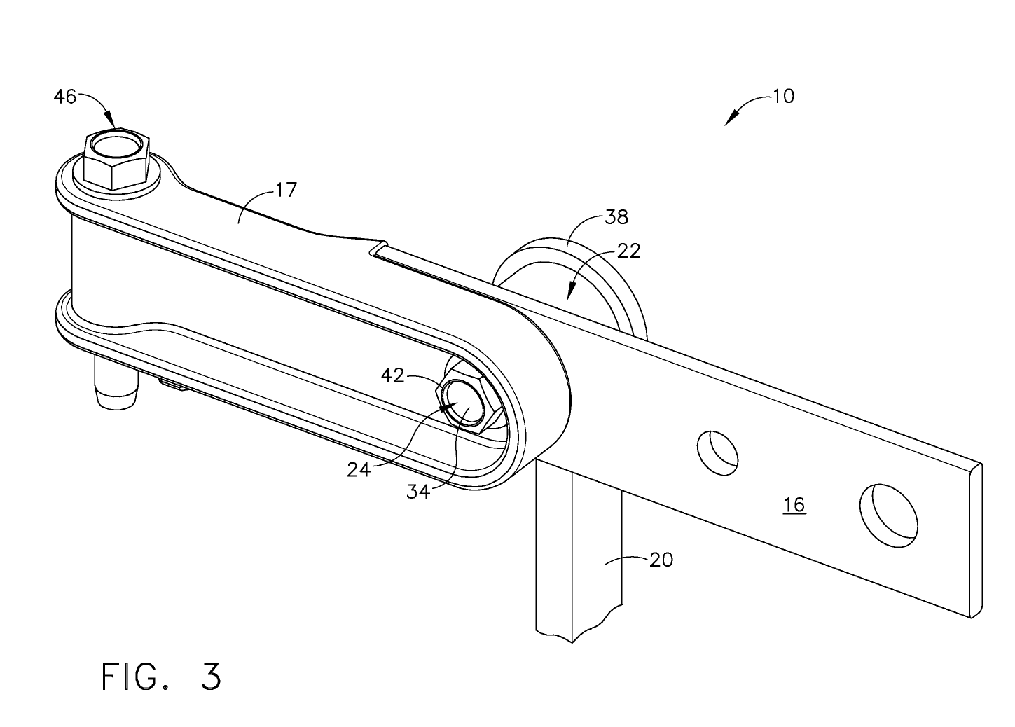

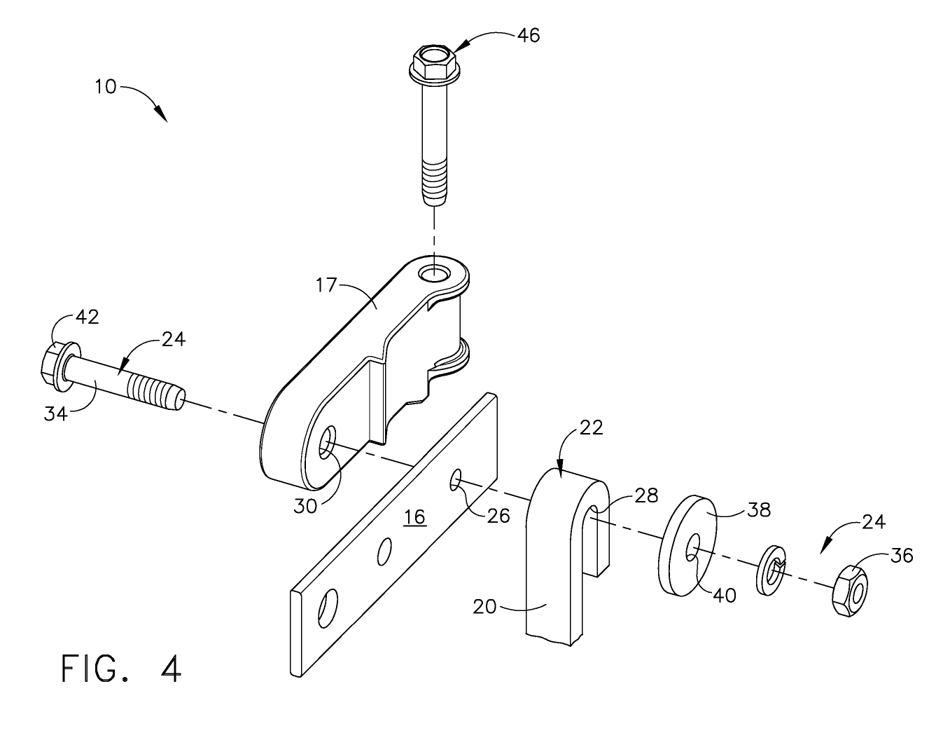

FIGS. 2 and 3 are perspective views of a portion of transformer 10. FIG. 4 is an exploded perspective view of the portion of transformer 10 shown in FIGS. 2 and 3. Terminals 16 are each electrically coupled to a corresponding coil 14 (shown in FIG. 1) to provide a circuit connection thereto. More specifically, in the exemplary embodiment each coil 14 includes two conductor windings 18 (shown in FIG. 1), each having an end portion 22. Each terminal 16 is electrically coupled to end portion 22 of a corresponding winding 18, such that each coil 14 includes two terminals 16 electrically coupled thereto, for example an input and an output terminal of each coil 14. Accordingly, in the exemplary embodiment transformer 10 includes six terminals 16, two for each coil 14. However, each coil 14 may have any number of terminals 16 electrically coupled thereto, which may depend upon a number of windings 18 of each coil 14. In the exemplary embodiment, transformer 10 includes a common terminal 19 (shown in FIG. 1), sometimes referred to as an x0 terminal. Common terminal 19 may have any location, orientation, and/or position with respect to frame 12 and/or any of other portion and/or component of transformer 10. In some embodiments transformer 10 does include common terminal 19.

In some embodiments of transformer 10, conductor winding end portions 22 are fixedly secured in electrical contact with a corresponding terminal 16 without being welded to the terminal 16. In other embodiments of transformer 10, end portions 22 may be fixedly secured in electrical contact with a corresponding terminal 16 using a combination of a weld and any other process, method, structure, and/or means. In addition to or alternative to a weld, end portions 22 may be fixedly secured in electrical contact with the corresponding terminal 16 using any suitable process, method, structure, and/or means other than a weld. For example, in one exemplary embodiment shown in FIGS. 2-4, a fastener 24 is received within an opening 26 within each terminal 16 and an opening 28 within conductor winding end portions 22 to fixedly secure each end portion 22 to the corresponding terminal 16. In the exemplary embodiment, fastener 24 is also received within an opening 30 of the corresponding insulator 17, such that a terminal 16 is coupled to the corresponding insulator 17 using the same fastener 24 that couples a conductor winding end portion 22 to the terminal 16 and at generally the same location on the terminal 16. However, in some embodiments, a different fastener 24 (including, but not limited to, other types of fasteners) may be used to couple end portions 22 to the corresponding terminal 16 than is used to couple terminals 16 to the corresponding insulators 17, and/or end portions 22 may be coupled to the corresponding terminals 16 at a different location on terminals 16 than where the corresponding insulators 17 are coupled. In some embodiments wherein one or more of coil winding(s) 18 is formed from a plurality of conductors 20, an end portion 22 of each coil winding conductor 20 may be separately fixedly secured to the corresponding terminal 16. In some embodiments wherein five or more coil winding conductors 20 are separately fixedly secured to terminal 16, a size of terminal 16 is increased to accommodate providing an increased surface area for attachment of the coil winding conductors 20. In one embodiment, the size of terminal 16 is increased by at least one of increasing a length of terminal 16, increasing a height of terminal 16, and increasing a width of terminal 16.

Fastener 24 may be any suitable size, shape, and/or type of fastener that enables fastener 24 to perform the functions described herein, such as, but not limited to, a threaded fastener and/or a rivet. For example, in some embodiments, terminal opening 26, insulator opening 30, and/or end portion opening 28 are at least partially defined by a thread, and fastener 24 includes a threaded portion that engages the thread of openings 26, 28, and/or 30 to fixedly secure end portions 22 to the corresponding terminal 16. In the exemplary embodiment, fastener 24 includes a bolt 34, a nut 36, and a pressure plate 38, sometimes referred to as a washer. When bolt 34 is received within terminal opening 26, end portion opening 28, insulator opening 30, and an opening 40 within pressure plate 38, a thread 42 on bolt 34 engages a thread (not shown) on nut 36 to fixedly secure end portions 22 to the corresponding terminal 16 between nut 36 and a head 42 of bolt 34. Pressure plate 38 may facilitate a more even distribution of pressure on terminal 16 and/or end portion 22 to facilitate a stronger connection the corresponding terminal 16 and end portion 22 and/or to facilitate avoiding damage to terminal 16 and/or end portion 22. In some embodiments, transformer 10 does not include pressure plate 38. Bolt 34 and nut 36 may have any suitable size and/or shape, and/or may have any suitable size, shape, and/or type of threads.

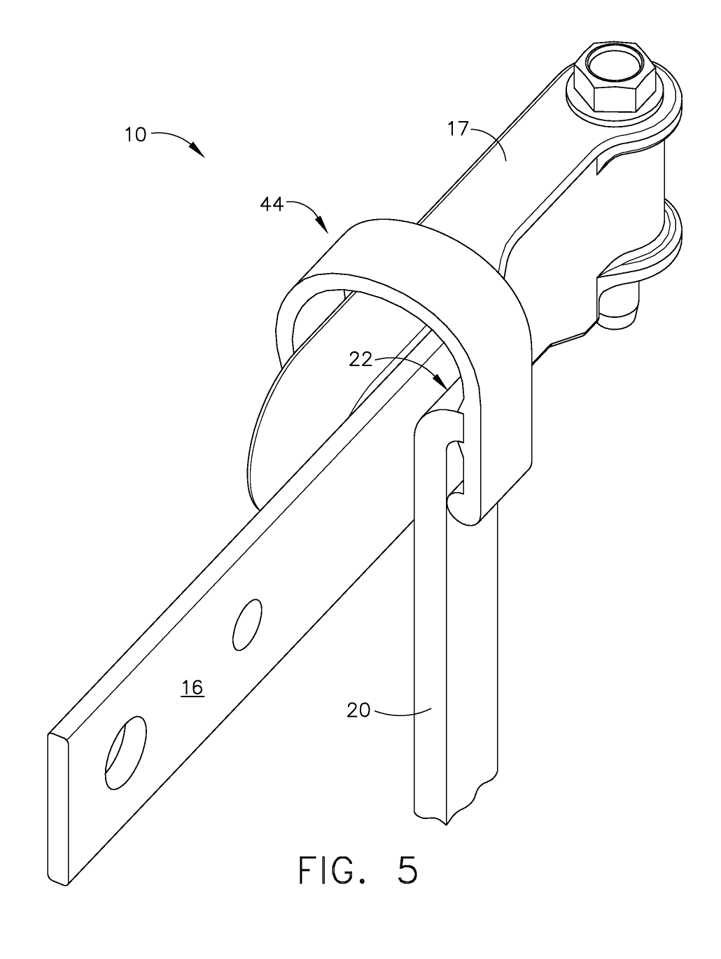

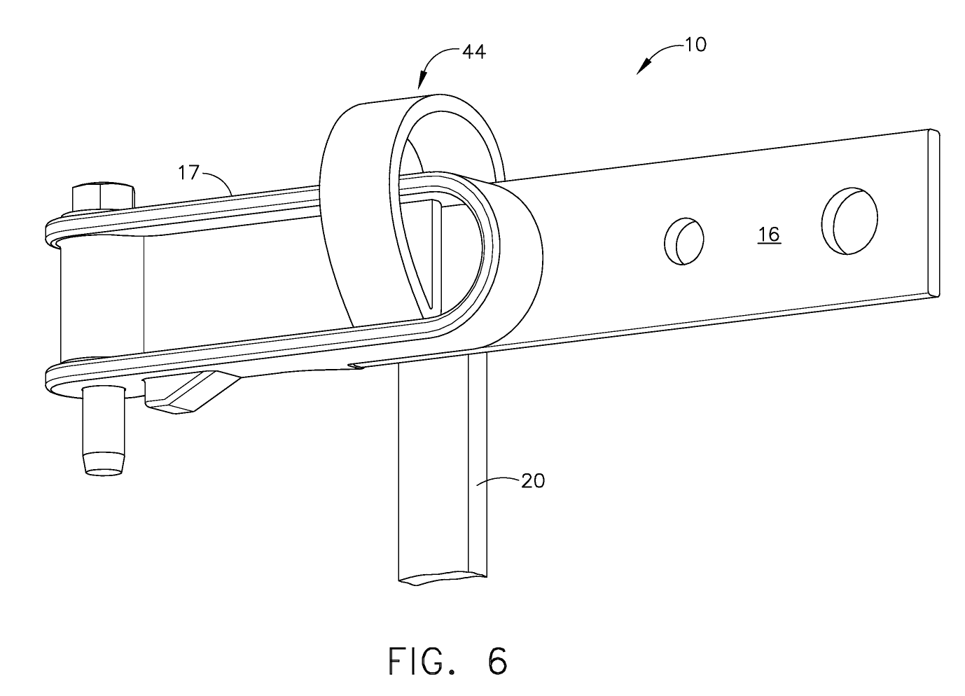

FIGS. 5 and 6 are perspective views of an alternative embodiment of transformer 10 wherein conductor winding end portions 22 are fixedly secured in electrical contact with a corresponding terminal 16 using an exemplary embodiment of a clamp 44. For example, as shown in FIGS. 5 and 6, clamp 44 applies pressure to terminal 16 and the corresponding conductor winding end portion 22 to fixedly secure each end portion 22 to the corresponding terminal 16. In some embodiments, a pressure plate (not shown) may be used facilitate a more even distribution of pressure on terminal 16 and/or end portion 22 to facilitate a stronger connection between the corresponding terminal 16 and end portion 22 and/or to facilitate avoiding damage to terminal 16 and/or end portion 22. In the exemplary embodiment, clamp 44 also applies pressure to the corresponding insulator 17, such that a terminal 16 is coupled to the corresponding insulator 17 using the same clamp 44 that couples the corresponding end portion to the terminal 16, and at generally the same location on the terminal 16. However, in some embodiments, a different clamp 44 (and/or different type of fastener) may be used to couple end portion 22 to the corresponding terminal 16 than is used to couple the terminal 16 to the corresponding insulator 17, and/or end portion 22 may be coupled to the corresponding terminal 16 at a different location on terminal 16 than where the corresponding insulator 17 is coupled. Clamp 44 may be any suitable size, shape, and/or type of clamp capable of performing the functions described herein. In some embodiments, terminal 16, end portion 22, insulator 17 if clamped by clamp 44, and/or clamp 44 may include an opening (not shown), an extension (not shown), and/or other suitable structure (not shown) and/or means (not shown) to facilitate alignment between end portion 22, the corresponding terminal 16, and/or the corresponding insulator 17.

By providing a non-welded electrical coupling between a terminal 16 and a corresponding conductor winding end portion 22, some embodiments of transformer 10 may facilitate reducing a cost of transformers and/or a cost of assembly thereof as compared to at least some known transformers, for example, because of equipment, supplies, and/or operator training associated with welding processes. Moreover, some embodiments of transformer 10 may also facilitate reducing a time of assembling a transformer as compared to at least some known transformers because of the elimination of a welding process.

Referring again to FIGS. 1-4, as described above transformer 10 includes a plurality of independent insulators 17 coupled to frame 12. Insulators 17 electrically insulate each of terminals 16 from each other and other components of transformer 10, such as, but not limited to frame 12. Insulators 17 may be coupled to frame 12 in any suitable fashion, manner, configuration, arrangement, location, orientation, method, process, and/or by any suitable structure and/or means that enable insulators 17 to perform the functions described herein. For example, and although insulators 17 may be coupled to frame 12 by other structure and/or means, in the exemplary embodiment insulators 17 are each coupled to frame 12 using a threaded fastener 46. In other embodiments, and for example, in addition or alternative to other structure and/or means, insulators 17 may each be coupled to frame 12 using a rivet (not shown). Insulators 17 may have any suitable size, shape, and/or may be formed from any materials that enable insulators 17 to perform the functions described herein.

In the exemplary embodiment, each terminal 16 is independently coupled to frame 12 using a corresponding independent insulator 17. More specifically, each insulator 17 is independently coupled to frame 12, and each terminal 16 extends from a corresponding insulator 17. In some embodiments, one or more terminals 16 are each integrally formed with the corresponding insulator 17. However, in the exemplary embodiment, each terminal 16 is coupled to a corresponding insulator 17. Terminals 16 may be coupled to the corresponding insulator 17 in any suitable fashion, manner, configuration, arrangement, location, orientation, method, process, and/or by any suitable structure and/or means. For example, in the exemplary embodiment terminals 16 are coupled to the corresponding insulators 17 using threaded fastener 24, as described above. Further, in an embodiment where the size of terminal 16 is increased because of a number of coil winding conductors 20 being coupled thereto, terminal 16 is mounted in at least one of a horizontal orientation, a vertical orientation, and any other orientation that reduces a distance from an end of terminal 16 to frame 12.

In some embodiments terminals 16 and insulators 17 are modular, such that differently sized, shaped, orientated, located arranged, configured, and/or different types of, transformer assemblies can use terminals 16 and/or insulators 17. Accordingly, transformer 10 may facilitate reducing a cost of transformers and/or a cost and/or time of assembly thereof as compared to at least some known transformers, because differently sized, shaped, orientated, located arranged, configured, and/or different types of, transformers may not need dedicated terminal board assemblies, terminals, and/or insulators fabricated specifically therefore. Moreover, in some embodiments, because terminals 16 and/or insulators 17 are modular, terminals 16 and/or insulators 17 may not require additional machining during assembly, which may facilitate reducing a cost of transformers and/or a time and/or cost of assembly thereof as compared to at least some known transformers.

Any of openings 28 and/or openings 26 may be referred to herein as a first, a second, a third, and/or a fourth opening. Any of conductor winding end portions 22 may be referred to herein as a first end and/or a second end. Any of coil windings 18 may be referred to herein as a first and/or a second conductor winding. Any of terminals 16 may be referred to herein as a first and/or a second terminal. Any of fasteners 24 may be referred to herein as a first and/or a second fastener. Any of insulators 17 may be referred to herein as a first and/or a second insulator.

Exemplary embodiments of transformers and methods are described and/or illustrated herein in detail. The transformers and methods are not limited to the specific embodiments described herein, but rather, components of each transformer, as well as steps of each method, may be utilized independently and separately from other components and steps described herein. Each component, and each method step, can also be used in combination with other components and/or method steps.

When introducing elements/components/etc. of the transformers and methods described and/or illustrated herein, the articles “a”, “an”, “the” and “said” are intended to mean that there are one or more of the element(s)/component(s)/etc. The terms “comprising”, “including” and “having” are intended to be inclusive and mean that there may be additional element(s)/component(s)/etc. other than the listed element(s)/component(s)/etc.

While the invention has been described in terms of various specific embodiments, those skilled in the art will recognize that the invention can be practiced with modification within the spirit and scope of the claims.

What is claimed is:

1. A transformer comprising:
a frame;
a coil comprising a conductor winding, said conductor winding comprising an end portion having a first opening;
a terminal coupled to said frame, said terminal comprising a second opening; and
a fastener received within said first and second openings, said fastener fixedly securing said conductor winding end portion to said terminal to electrically couple said conductor winding to said terminal.

2. A transformer in accordance with claim 1 wherein said terminal comprises a plurality of second openings to facilitate coupling a plurality of conductor winding end portions to said terminal, and wherein a size of said terminal is increased to provide an increased surface area for coupling said plurality of conductor winding end portions.

3. A transformer in accordance with claim 2 wherein said terminal is coupled to said frame in at least one of a vertical orientation, a horizontal orientation, and any other orientation that reduces a distance from a terminal end to said frame.

4. A transformer in accordance with claim 1 wherein said conductor winding is a first conductor winding, said terminal is a first terminal, and said fastener is a first fastener, said coil further comprising a second conductor winding and a second terminal fixedly secured together by a second fastener received within said first opening of said end portion of said second conductor winding and said second opening of said second terminal.

5. A transformer in accordance with claim 1 wherein said conductor winding comprises a plurality of conductors.

6. A transformer in accordance with claim 1 wherein said fastener comprises at least one of a threaded portion and a rivet.

7. A transformer in accordance with claim 1 wherein at least one of said first and second openings is at least partially threaded.

8. A transformer in accordance with claim 1 wherein said fastener comprises a bolt and a pressure plate, said pressure plate positioned at least partially between a head of said bolt and said conductor winding end portion to facilitate fixedly securing said conductor winding end portion to said terminal.

9. A transformer in accordance with claim 1 further comprising an insulator extending from said frame, wherein said terminal is coupled to said insulator by said fastener.

10. A transformer comprising:
a frame;
a coil comprising a first conductor winding and a second conductor winding;
a first insulator coupled to said frame;
a first terminal extending from said first insulator to facilitate electrically isolating said first terminal from said frame, said first terminal electrically coupled to said first conductor winding;
a second insulator independent from said first insulator and coupled to said frame, wherein said first and second insulators are independently coupled to said frame; and
a second terminal electrically coupled to said second conductor winding, said second terminal extending from said second insulator to facilitate electrically isolating said second terminal from said frame and said first terminal.

11. A transformer in accordance with claim 10 wherein at least one of said first terminal and said second terminal is electrically coupled to a plurality of conductor windings, and wherein a size of said terminal is increased to provide an increased surface area for coupling said plurality of conductor windings.

12. A transformer in accordance with claim 11 wherein at least one of said first terminal and said second terminal is coupled to said frame in at least one of a vertical orientation, a horizontal orientation, and any other orientation that reduces a distance from a terminal end to said frame.

13. A transformer in accordance with claim 10 wherein said first terminal is coupled to said first insulator and said second terminal is coupled to said second insulator.

14. A transformer assembly in accordance with claim 11 wherein said first is coupled to said first insulator and said second terminal is coupled to said second insulators., using at least one of a threaded fastener and a rivet.

15. A transformer assembly in accordance with claim 10 wherein said first terminal is integrally formed with said first insulator and second terminal is integrally formed with said second insulator.

16. A transformer comprising:
a frame;
a coil comprising a conductor winding, said conductor winding comprising an end portion;
a terminal coupled to said frame; and
a clamp fixedly securing said conductor winding end portion to said terminal to electrically couple said conductor winding to said terminal.

17. A transformer in accordance with claim 16 wherein said terminal is coupled to a plurality of conductor winding end portions, wherein a size of said terminal is increased to provide an increased surface area for coupling said plurality of conductor winding end portions, and wherein said terminal is coupled to said frame in at least one of a vertical orientation, a horizontal orientation, and any other orientation that reduces a distance from a terminal end to said frame.

18. A transformer in accordance with claim 13 wherein said conductor winding is a first conductor winding, said terminal is a first terminal, and said clamp is a first clamp, said transformer further comprising a second conductor winding and a second terminal fixedly secured together by a second clamp.

19. A transformer in accordance with claim 13 wherein said conductor winding comprises a plurality of conductors.

20. A transformer in accordance with claim 13 further comprising an insulator extending from said frame, wherein said terminal is coupled to said insulator by said clamp.
